(19) United States
(12) Patent Application Publication
(10) Pub. No.: US 2007/0287418 A1
(43) Pub. Date: Dec. 13, 2007

(54) Establishing Data Communications

(75) Inventor: Sridhar Reddy, Austin, TX (US)

Correspondence Address: ANDREA E. TRAN;PRAMUDJI WENDT & TRAN, LLP, 1800 BERING DRIVE, SUITE 540, HOUSTON, TX, 77057, US

(73) Assignee: Dell Products L.P., Round Rock, TX (US)

(21) Appl. No.: 11/423,752

(22) Filed: Jun. 13, 2006

(51) Int. Cl. H04M 3/16

(52) U.S. Cl. 455/410

(57) ABSTRACT

An information handling system (IHS) includes a transceiver for receiving a wireless transmission communication packet, a physical channel for communication, a filter to block data and a processor to receive unblocked data to obtain a parameter from the wireless communication packet unblocked to determine a frequency hopping sequence and an initial link key for trusted communication with the IRS.

### BACKGROUND

### TECHNICAL FIELD

The disclosure relates to wireless radio.

### BACKGROUND INFORMATION

As the value and use of information continues to increase, individuals and businesses seek additional ways to process and store information. One option available to users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY

In one embodiment, a method for establishing a trusted communication link between a first device and a second device includes blocking at the first device, at least a portion of data in a data packet transmitted from the second device, to obtain unblocked data. A frequency hopping sequence is determined using at least a portion of the unblocked data. A connection on a physical channel is established between the first device and the second device with the frequency hopping sequence and an initial link key is established using at least a portion of the unblocked data.

In another embodiment, a set of application program interfaces embodied on a computer readable medium for execution by a processor included in a first device for establishing a trusted communication link with a second device includes a first interface that receives data from a first portion of a wireless data packet transmitted from the second device to obtain at least a portion of an unblocked packet data, wherein a second portion of the data in the wireless data packet is blocked packet data, a second interface that receives data extracted from at least a portion of the unblocked packet data to determine a frequency hopping sequence for establishing a communication link with the second device a third interface that receives data from a connection on a physical channel associated with the communication link and a fourth interface that receives an initial link key for establishing the communication link as a trusted communication link between the first device and the second device, wherein the initial link key is associated with at least a portion of the unblocked packet data.

In another embodiment an information handling system (IHS) includes a transceiver configured to receive a wireless transmission communication data packet, a physical channel for communication of the data packet and a processor configured to process instructions to block at least a portion of data in the wireless communication packet wherein unblocked data is used to determine a frequency hopping sequence and an initial link key for trusted communications.

### BRIEF DESCRIPTION OF THE DRAWINGS

FIG. 1 is a schematic illustration of an Information Handling System within which a set of instructions, when executed, may cause the system to perform any one or more of the methodologies of embodiments disclosed herein,

FIG. 2 is a schematic of BLUETOOTH piconets;

FIG. 3 is a schematic of a BLUETOOTH scatternet;

FIG. 4 is a schematic diagram depicting a BLUETOOTH linking sequence;

FIG. 5A is a schematic of a Frequency Hopping Synchronization packet;

FIG. 5B is a schematic of a BLUETOOTH device address format;

FIG. 6 is a schematic diagram depicting a BLUETOOTH linking sequence with malicious code delivery potential;

FIG. 7 is a schematic diagram depicting a BLUETOOTH linking sequence filtering potentially malicious code;

FIG. 8 is a schematic diagram depicting a BLUETOOTH linking sequence establishing authentication; and

FIG. 9 is a flow chart illustrating a method of establishing data communication.

### DETAILED DESCRIPTION

BLUETOOTH is a short-range wireless radio technology distributed under the BLUETOOTH trademark. BLUETOOTH associated technology makes it possible to transmit signals over short distances between Information Handling Systems including computers, telephones, headsets, printers, microphones and other devices and thereby simplify communication and synchronization between devices. BLUETOOTH enables eliminating wires and cables between both stationary and mobile devices, facilitates both data and voice communication and also enables ad hoc networks. BLUETOOTH includes hardware, software and interoperability requirements. BLUETOOTH communications uses a fast acknowledgement with frequency-hopping schemes to make the robust links, even in noisy environments.

BLUETOOTH devices discover and connect to each other via a pairing, or bonding, process. This process is governed, in part, by a link controller portion of the BLUETOOTH radio. The detailed process is described in the BLUETOOTH 2.0+EDR specification (4 Nov. 2004), published by BLUETOOTH SIG, Inc., entitled “Specification of the BLUETOOTH System” and is hereby incorporated by referenced.

BLUETOOTH devices may be found in at least three major states including: Standby, Connection, and Park. In addition, there may be seven substates, page, page scan, inquiry, inquiry scan, Master response, Slave response, and inquiry response. The substates are interim states that may be used when establishing connections and enabling device discovery. To move from one state or substate to another, either commands from device's Link Manager (LM) are used, or internal signals in the link controller are used (such as the trigger signal from the correlator and the timeout signals).

For purposes of this disclosure, an embodiment of an Information Handling System (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific control, or other purposes. For example, an IHS may be a personal computer, a network storage device, or any other suitable device and may vary in size, shape, performance, functionality, and price. The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, and a video display. The IHS may also include one or more buses operable to transmit data communications between the various hardware components.

BLUETOOTH devices negotiate with other devices to form trusted communication links. Trusted communication links provide a secure way for communicating parties to authenticate themselves to each other without the risk of an eavesdropper subsequently masquerading as one of the parties. Trusted communication provide a secure way of generating and verifying check values for data integrity, as well as for data encrypting and decrypting for confidentiality and other purposes. There are several methods for trusted communication. Trusted communication may provide a way to produce an irreversible hash of data for support of digital signature and non-repudiation functions. Trusted communication may include generation, derivation, distribution, storage, retrieval and deletion of cryptographic keys.

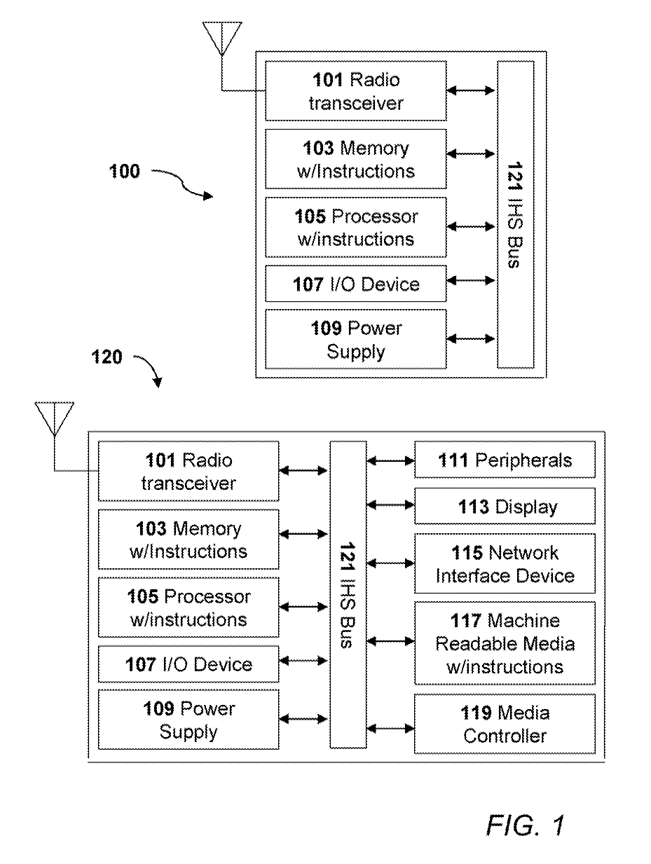

As a non-limiting example of an IHS, FIG. 1 illustrates an embodiment of an IHS 100 within which a set of instructions may enable the system to perform any of the embodiments disclosed herein. IHS 100 may be a standalone system or connected to other systems within a network, piconet or scatternet. IHS 100 includes a radio transceiver 101 connected to an antenna for providing wireless access to systems, networks and devices. Radio transceiver 101 may be a BLUETOOTH radio transceiver, and may be a combination of a separate receiver and a transmitter. In a networked deployment, the IHS 100 may operate as a server or a client in server-client networked environment or as a member of a distributed network environment. As a non-limiting example, memory 103 may be volatile or non-volatile memory and have instructions and/or data. For example, the memory may include a BLUETOOTH stack protocol. A central processing unit (CPU) 105 may be included with instructions. These instructions may at least partially reside within memory 103 and/or within processor 105 during execution. Memory 103 is, and processor 105 may include, machine-readable media.

Non-limiting examples of machinereadable media include solid-state memory such as cards or other non-volatile memories, random access memories or other volatile memories, magneto-optical or optical media (e.g., disk or tape), signals embodying computer instructions in a transmission medium. Machine-readable media as used herein include equivalents and successor media.

Input/output device 107 is provided to send data to, or receive data from, other system components or devices. Power supply 109, which may be any suitable type of power supply, provides energy to the system. At least one IHS bus 121 provides communication between and among components.

Additionally, IHS 100 may be expanded as illustrated with IHS 120 to include additional peripherals 111, non-limiting examples include keyboards, Global Positioning System receivers, Universal Serial Bus adapter, headphones, microphone, wireless audio transmitter, print adapter, mouse, serial adapter, etc One or more of various types of display device 113 may be attached or linked with IHS 120. Network interface equipment 115 may provide hardwired access to infrastructure, or may be linked to other wireless infrastructure. A non-limiting example is a Network Interface Controller (NIC). Other interfaces may include a Peripheral Component Interconnect (PCI) bus, Universal Serial Bus (USB) port, etc. A machine readable medium with instructions 117, a disk drive device is a non-limiting example, to provide additional software and data storage capability to IHS 120.

Processor 105 may carry out any number of functions, non-limiting examples include graphics/memory controller hub functions and enable I/O functions for I/O device 107 and associated peripherals 111. Peripherals 111 such as a mouse, keyboard, and tablet may also be coupled to other components and peripherals 111 at the option of the user. IHS bus 121 may connect to I/O devices 107, non-limiting examples include a PCI bus, PCI Express bus, SATA bus or other bus may be coupled to enable IHS bus 121 to be connected to other devices which provide IHS 100 or 120 with additional functionality as desired. A universal serial bus (USB) or other I/O bus may be coupled to IHS bus 121 to facilitate the connection of peripheral devices 111 to IHS 100 or 120. System basic input-output system (BIOS) may be coupled to processor 105. BIOS software may be stored in processor 105 or in nonvolatile memory 103 such as CMOS or FLASH memory. A network interface controller (NIC) 116 may be coupled to processor 105 to facilitate connection of system 100 or 120 to other information handling systems. A media drive controller 119 is coupled to processor 105 through bus 121. Devices that can be coupled to media drive controller 119 include CD-ROM drives, DVD drives, hard disk drives and other fixed or removable media drives. It should be understood that the technology disclosed herein is not only applicable to the embodiment of FIG. 1 but is also applicable to the other types of Information Handling Systems.

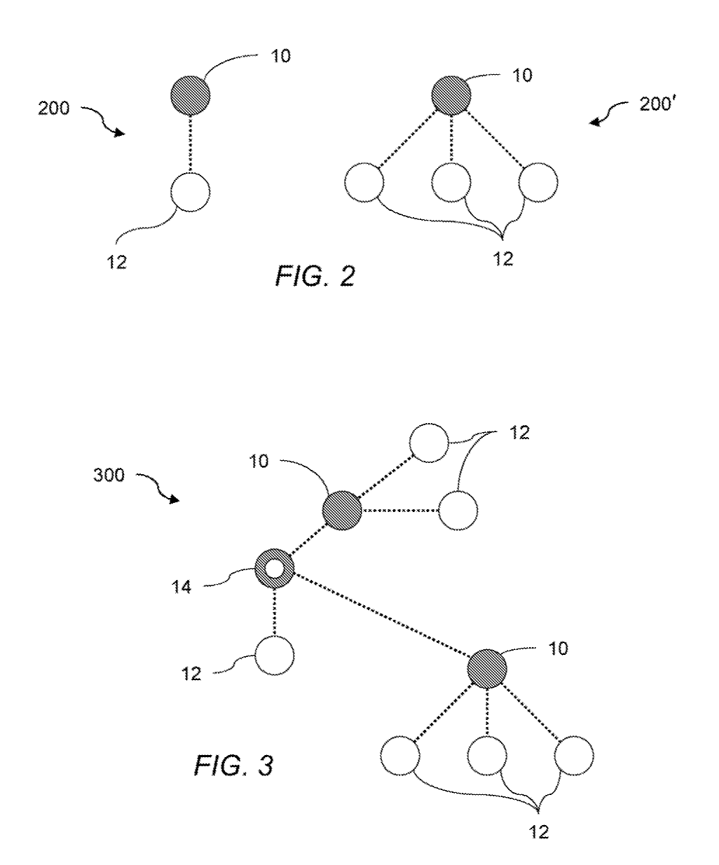

FIG. 2 is a schematic of BLUETOOTH piconet 200 and BLUETOOTH piconet 200 that may use two or more IHSs. A piconet 200 is a collection of devices occupying a shared physical channel where one of the devices is the Piconet Master 10 and the remaining devices 12 are connected over the physical channel to the Piconet Master 10. The Piconet Master 10 is the device in piconet 200 or 200′ wherein a BLUETOOTH Clock and BLUETOOTH Device Address are used to define piconet physical channel characteristics. A piconet Slave 12 is any device in piconet 200 or 200′ that is not the Piconet Master 10, but is connected to the Piconet Master 10.

FIG. 3 is a schematic of a BLUETOOTH scatternet 300. A scatternet 300 is a collection of two or more piconets that include one or more devices acting as a Participant of Multiple Piconets (PMP). A PMP is a device that is concurrently a member of more than one piconet, which may be achieved using time division multiplexing (TDM) to interleave its activity on each piconet physical channel. Each piconet has a single Master. However, Slaves can participate in a plurality of piconets on a time-division multiplex basis. In addition, a Master in one piconet may be a Slave in other piconets (e.g. 14). Piconets are not frequency synchronized and each piconet has a separate hopping sequence. Examples of systems illustrative of Master devices or Slave devices that may participate in piconets and scatternets are IHS 100 and IHS 120 in FIG. 1.

A Piconet Physical Channel, the lowest architectural layer in the BLUETOOTH system, is divided into time slots in which each slot is related to a Radio Frequency (RE) hop frequency. Consecutive hops normally correspond to different RF hop frequencies. These consecutive hops follow a pseudo-random hopping sequence, hopping through a 79 RE channel set. A basic piconet physical channel may be shared by any number of BLUETOOTH devices, limited only by the resources available on the piconet Master device. Only one device is the piconet Master, all others being piconet Slaves. All communication is between the Master and Stave devices. There is no direct communication between Slave devices on the piconet channel.

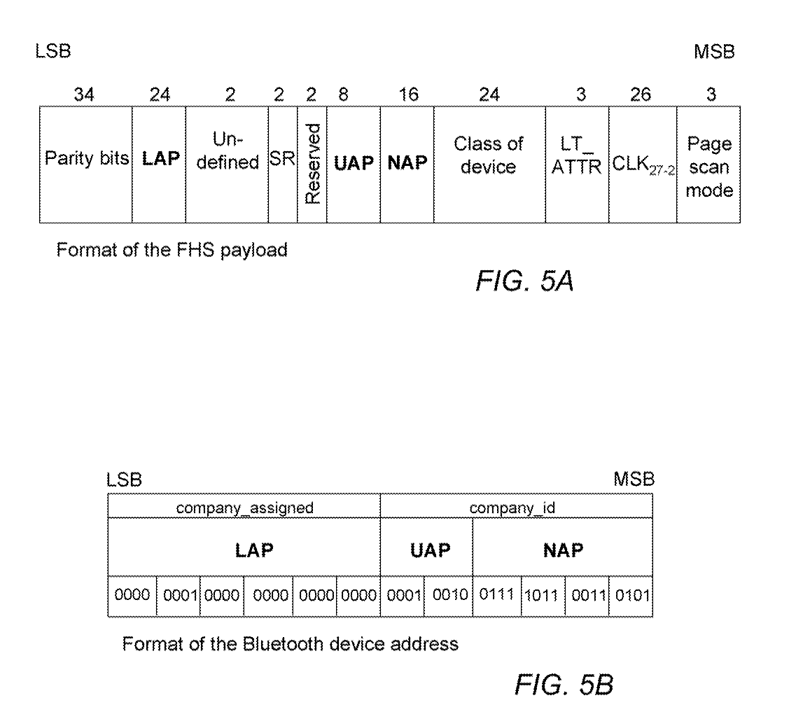

Physical channels are defined by a pseudo-random RF channel hopping sequence, the packet (slot) timing and an access code. The hopping sequence may be determined with data associated with a BLUETOOTH device address (See FIGS. 5A and 5B). The phase in the hopping sequence is determined by the BLUETOOTH clock. All physical channels are subdivided into time slots whose length is different depending on the physical channel. Within the physical channel each reception or transmission event is associated with a time slot or time slots. For each reception or transmission event an RF channel is selected by the hop selection kernel. Under current BLUETOOTH protocol the maximum hop rate may be 1600 hops/s in the Connection state and the maximum may be 3200 hops/s in the inquiry and page substates.

Because the number of RF carriers may be limited so that many BLUETOOTH piconets may operate independently in the same area, independent devices may have their transceivers tuned to the same RF carrier, resulting in physical channel collisions. To mitigate collisions, an access code that is used as a correlation code by devices tuned to the physical channel is always present at the start of every transmitted packet.

Two physical channels (called the basic piconet channel and adapted piconet channel) are used for communication between connected devices and are associated with a specific piconet. During the Connection state, a default channel is used, usually the basic piconet channel. Other physical channels are used for discovering BLUETOOTH devices (the inquiry scan channel) and for connecting BLUETOOTH devices (the page scan channel.) Whenever a BLUETOOTH device is synchronized to the timing, frequency and access code of a physical channel it is said to be ‘Connected’ to this channel (whether or not it is actively involved in communications over the channel.) It should be understood that BLUETOOTH protocol/details are subject to change at any time by industry agreement, but such changes do not affect the scope of the claims.

BLUETOOTH uses Link Manager Protocol (LMP) to control and negotiate aspects of the operation of the BLUETOOTH Connection between two devices. This includes the set-up and control of logical transports and logical links, and for control of physical links. The Link Manager Protocol is used to communicate between the Link Managers (LM) on the two devices which may be connected by the Asynchronous Connection-oriented (ACL) logical transport. All LMP messages apply to the physical link and associated logical links and logical transports between the sending and receiving devices.

The protocol is made up of a series of messages which may be transferred over the logical link on a default ACL logical transport between two devices. LMP messages may be interpreted and acted-upon by the LM and may not be propagated to higher protocol layers.

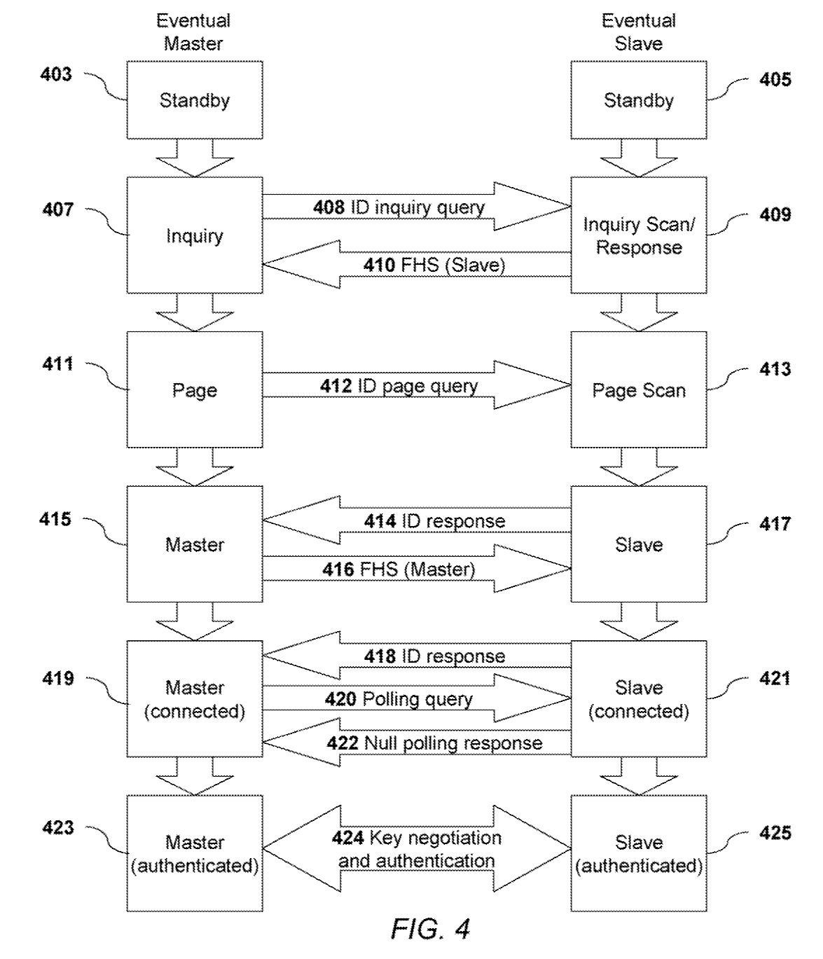

FIG. 4 is a schematic of an Eventual BLUETOOTH Master device connecting with an Eventual BLUETOOTH Slave device. As illustrated in FIG. 4, an Eventual Master device and an Eventual Slave device may reside in Standby mode, 403 and 405, respectively. The Standby state is the default state in a BLUETOOTH device. In this state, the device may be in a low-power mode. The BLUETOOTH Master controller may leave the Standby mode to transmit an Inquiry 407 such as ID query 408 or receive an incoming Frequency Hopping Synchronization (FHS) packet 410. The BLUETOOTH Slave controller may leave the Standby state to scan (409 or 413) for an inquiry (408) or ID page (412) message, or to transmit an FHS Packet 410.

Two phases prior to BLUETOOTH devices negotiating and authenticating a key exchange (called Link Manager Protocol Pairing or LMP-pairing) to establish a bond that the devices are trusted to each other are the inquiry phase and the paging phase. A ‘bond’ is a relation between two BLUETOOTH devices defined by creating, exchanging and storing a common link key. The bond is created through bonding or LMP-pairing procedures. Bonding is a relationship between BLUETOOTH devices based on a common link key. The link key is created during the bonding procedure and stored by both BLUETOOTH devices for future authentication. The bonding procedure may begin with the creation of an initial link key, which occurs prior to creation of the link key that may be used subsequent to an initial authentication.

Device discovery occurs during the inquiry phase substate. Information including device addresses may be exchanged during the inquiry phase. The page substate phase is used by the Master (source) to activate and connect to a Slave (destination) in the page scan substate. The Master tries to coincide with the Slave's scan activity by repeatedly transmitting the paging message consisting of the Slave's device access code (DAC) in different hop channels. The Master may determine which hop channels to best transmit on by knowing the BLUETOOTH address of the Slave acquired from the FHS response packet (e.g., 410) transmitted from the Slave.

The purpose of device discovery is to provide the discovery initiator with the BLUETOOTH Device Address, clock, Class of Device, used page scan mode and BLUETOOTH device name of discoverable devices. In order to discover other devices, a device enters an inquiry substate (i.e., 407 for the Eventual Master). In this substate>the Eventual Master may repeatedly transmit an inquiry message 408 at different hop frequencies. The inquiry hop sequence is derived from the Lower Address Part (LAP) of the general inquiry access code (GIAC). Even when dedicated inquiry access codes (DIACs) are used (to discover specific types or classes of devices)>the applied hopping sequence is generated from the GIAC LAP. A device that allows itself to be discovered (e.g., the Eventual Slave of FIG. 4), may regularly enter the inquiry scan substate 409 to respond to inquiry messages by sending a Frequency Hopping Synchronization (FHS) transmission 410. The inquiry response is optional and a device is not forced to respond to an inquiry message.

During the inquiry substate 407, the discovering device (the Eventual Master) collects the BLUETOOTH device addresses and clocks of all devices that respond to the inquiry message (from the FHS packet of the sender). It may then make a connection to any of them using the page procedure. The inquiry message 408 broadcast by the source does not contain source information. However, the inquiry message may indicate that a particular class of devices is requested to respond. There is one general inquiry access code (GIAC) to inquire for any device, and several dedicated inquiry access codes (DIAC) to inquire for a certain device types.

As illustrated in FIG. 5A, from least significant bit (LSB) to most significant bit (MSB), the FHS packet (e.g., 410) consists of eleven fields. The FHS packet may be used as a page response or an inquiry response, and also may be used for frequency hop synchronization. The LAP, UAP and NAP fields together (as illustrated in FIG. 5B) form the 48-bit BLUETOOTH Device Address of the device that sends the FHS packet. Each BLUETOOTH device is allocated a unique 48-bit BLUETOOTH device address. This address may be obtained from the IEEE Registration Authority. The address is divided into the following three fields: LAP field: lower address part consisting of 24 bits; UAP field: upper address part consisting of 8 bits: NAP field, non-significant address part consisting of 16 bits.

The other fields in the FHS packet include parity bits (a 34-bit field containing parity bits that form the first part of the sync word of the access code of the device that sends the FHS packet. These bits are derived from the LAP), Undefined (2 bits set to 0), SR (this 2-bit field is the scan repetition field and indicates the interval between two consecutive page scan windows), a 2-bit reserved field that may be set to 10, Class of device (This 24-bit field shall contain the class of device of the device that sends the FHS packet), LT_ADDR(a 3-bit field containing the logical transport address the recipient uses if the FHS packet is used at connection setup. A slave responding to a master or a device responding to an inquiry request message may include an all-zero LT_ADDR field if it sends the FHS packet), CLK (a 26-bit field containing the value of the native clock of the device that sends the FHS packet, sampled at the beginning of the transmission of the access code of this FHS packet. This clock value has a resolution of 1.25 ms, which is a two-slot interval. For each new transmission, this field is updated so that it accurately reflects the realtime clock value), Page scan mode (a 3-bit field indicating which scan mode is used by default by the sender of the FHS packet).

When initializing the Head-Error-Check (HEC) and Cyclic Redundancy Check (CRC) for the FHS packet of inquiry response, the UAP may be the Default Check Initialization (DCI). The LAP and UAP form the significant part of the BLUETOOTH device address. Using the parity bits and the LAP, the recipient can directly construct the channel access code of the sender of the FHS packet. The GIAC LAP and the four LSBs of the DCI, or the UAP, may be used as address input for the hopping sequence generator. During each page scan substate scan-window, the listening device may listen at a single hop frequency, its correlator matched to its Device Access Code (DAC). The scan window is long enough to scan 16 page frequencies.

In order to establish a BLUETOOTH Connection between devices the paging procedure may be used. A ‘page’ is transmission by a device of page trains containing the Device Access Code of the device to which the physical link is requested. The BLUETOOTH device address (of the Eventual Slave) is used to set up a BLUETOOTH Connection. Knowledge about the clock, obtained from the inquiry procedure or from a previous connection with this device, and the page scanning mode of the other device will accelerate the setup procedure A device that establishes a connection by initiating a paging procedure will automatically become the Master of the connection.

The page procedure in the Master consists of a number of steps. First, the Host communicates the BLUETOOTH Device Address of the Slave to the Controller. The Slave's BLUETOOTH device address may be used by the Master to determine the page hopping sequence For the phase in the sequence, the Master uses an estimate of the Slave's clock. For example, this estimate can be derived from timing information that was exchanged during the last encounter with this particular device (which could have acted as a Master at that time), or from an inquiry procedure. With this estimated clock time (CLKE) of the Slave's BLUETOOTH clock, the Master can predict on which hop channel the Slave starts page scanning.

The Master's estimate of the BLUETOOTH clock in the Slave may be completely wrong. Although the Master and the Slave use the same hopping sequence, they use different phases in the sequence and may never select the same frequency. To compensate for the clock drifts, the Master may send its page message during a short time interval on a number of wake-up frequencies. It may transmit also on hop frequencies just before and after the current, predicted hop frequency. During each transmit (TX) slot, the Master may sequentially transmit on two different hop frequencies. In the following receive (RX) slot, the receiver listens sequentially to two corresponding RX hops for an ID packet. The RX hops may be selected according to the page response hopping sequence. The page response hopping sequence may be related to the page hopping sequence: for each page hop there is a corresponding page response hop. In the next TX slot, it may transmit on two hop frequencies different from the former ones.

As illustrated in FIG. 4, Eventual Master (source) uses the page substate to activate and connect to an Eventual Slave (destination) in the page scan substate. The Master tries to coincide with the Slave's scan activity by repeatedly transmitting the paging message consisting of the Slave's device access code (DAC) in different hop channels. A ‘page scan’ occurs when a listening device listens for page trains containing its own Device Access Code.

Since the BLUETOOTH clocks of the Master and the Slave are not synchronized, the Master does not know exactly when the Slave wakes up and on which hop frequency. Therefore, the Master transmits a train of identical page scan messages at different hop frequencies and listens in between the transmit intervals until it receives a response from the Slave.

When a page message is successfully received by the Slave, there is a coarse Frequency Hopping (FH) synchronization between the Master and the Slave. Both the Master and the Slave enter a response substate to exchange information to continue the connection setup. It is beneficial for the piconet connection that both devices use the same channel access code, the same channel hopping sequence, and their clocks are synchronized. These parameters may be derived from the Master device. The device that initializes the connection (starts paging) is defined as the Master device (which is thus only valid during the time the piconet exists). The channel access code and channel hopping sequence after connection may be derived from the BLUETOOTH device address of the Master. The timing may be determined by the Master clock. An offset may be added to the Slave's native clock to temporarly synchronize the Slave clock to the Master crock. At start-up, the Master parameters are transmitted from the Master to the Slave.

TABLE 1

| | | | | | Access |
|---|---|---|---|---|---|
| | | Packet | | Hopping | Code and |
| Step | Message | type | Direction | Sequence | Clock |
| 1 | Page | ID | Master to | Page | Slave |
| | | | Slave | | |
| 2 | First Slave page | ID | Slave to | Page | Slave |
| | response | | Master | response | |
| 3 | Master page | FHS | Master to | Page | Slave |
| | response | | Slave | | |
| 4 | Second Slave | ID | Slave to | Page | Slave |
| | page response | | Master | response | |
| 5 | 1^{st} packet Master | POLL | Master to | Channel | Master |
| | | | Slave | | |
| 6 | 1^{st} packet Master | Any type | Slave to | Channel | Master |
| | | | Master | | |

A page messaging sequence between Master and Slave leading to Master-Slave connection is shown in Table 1 and follows the paging sequence in FIG. 4 from 411 to 423. A page hopping sequence has 32 wake-up frequencies distributed equally over the 79 MHz, with a period length of 32. The frequencies of the initial associated page hopping sequence are determined by the Slave's BLUETOOTH device address (e.g., from FHS packet 410 acquired during inquiry phase). The frequencies from Slave to Master are the corresponding page-response frequencies. The frequencies belong to the basic channel hopping sequence (as may be determined following the BLUETOOTH Specification).

In step 1 of Table 1, the Master device is in page substate (411) and the Slave device in the page scan substate 413. Assume in this step that the page message, ID page query 412, sent by the Master reaches the Slave. On receiving the page message 412, the Slave enters the Slave response substate in step 2 (ID response packet 414 is sent from 417 to 415). The Master waits for a reply from the Slave and when this arrives in step 2, the Master will enter the Master response in step 3 (FHS packet 416 sent from Master 415 to Slave 417). Note that during the initial message exchange, all parameters are derived from the Slave's device address, and that the page hopping and page response hopping sequences are derived from the Slave's device address When the Master and Slave enter their response states, their respective clock inputs to the page and page response hop selection is frozen in order to eliminate the possibility of losing the link due to discrepancies of the native clock (CLKN) and the Master's clock estimate (CLKE).

After having received the page message 412 in step 1, the Slave device transmits a Slave page response message 414 (containing information for the Slave's device access code) in step 2. The Slave may transmit this response 625 μs after the beginning of the received page message and at the response hop frequency that corresponds to the hop frequency in which the page message was received. The Slave transmission is therefore time aligned to the Master transmission. During initial messaging, the Slave may use the page response hopping sequence to return information to the Master. The clock input CLKN may be frozen at the value it had at the time the page message was received.

After having sent the response message, the Slave's receiver may be activated 312.5 μs after the start of the response message and awaits the arrival of a Master FHS packet 416 from Master to Slave (Step 3 in Table 1 and Master FHS packet 416 from 415 to 417). An FHS packet can arrive 312.5 μs after the arrival of the page message and not after 625 μs as is usually the case in the piconet physical channel RX/TX timing.

If the setup fails before a BLUETOOTH Connection state has been reached, the Slave listens as long as no FHS packet is received until a pager-response time-out parameter is exceeded. Every 1.25 ms, how ever, it selects the next Master-to-Slave hop frequency according to the page hop sequence. If nothing is received after the pager-response time-out parameter, the Slave returns to the page scan substate for one scan period. Length of the scan period depends on the synchronous reserved slots present. If no page message is received during this additional scan period, the Slave may resume scanning at its regular scan interval and return to the state it was in prior to the first page scan state.

If an FHS packet is received by the Slave (e.g., 416) when the Slave is in the Slave response substate, the Slave may return a Slave page response message in step 4 (ID response 418, as in 421 to 419) to acknowledge reception of the Master FHS packet 416. This response 418 may use the page response hopping sequence. The transmission of the Slave page response packet is based on the reception of the Master FHS packet 416. The Slave then changes to the Master's channel access code and clock as received from information associated with the Master FHS packet 416. The 26 Most Significant Bits (MSBs) of the Master clock are transferred. The offset between the Master's clock and the Slave's clock may be determined from the Master's clock in the FHS packet 416.

Finally, the Slave enters the Connection state in Table 1 step 5. From then on, the Slave uses the Master's clock and the Master's BLUETOOTH device address to determine the basic channel hopping sequence and the channel access code. The connection mode starts with a POLL query packet 420 transmitted by the Master (419 to 421). The Slave may respond with any type of packet (e.g., 422 a Null polling response). If the POLL packet 420 is not received by the Slave, or the response packet 422 is not received by the Master, within a predetermined number of slots (or time) after FHS packet acknowledgement 418, the Master and the Slave return to page and page scan substates, respectively

When the Master has received a Slave page response message 414 in step 2, it enters the Master response routine. The Master freezes the current clock input to the page hop selection scheme. The Master then transmits a Master FHS packet (416) in step 3 containing the Master's real-time BLUETOOTH clock the Masters BLUETOOTH device address, parity bits, and class of device information. The FHS packet contains information to construct the channel access code without a mathematical derivation from the Master's BLUETOOTH device address. The Logical Transport Address field in the packet header of FHS packets in the Master response substate may be set to all-zeros. The FHS packet may be transmitted at the beginning of the Master-to-Slave slot following the slot in which the Slave responded. The TX timing of the FHS packet is not based on the reception of the response packet from the Slave. The FHS packet may therefore be sent 312.5 μs after the reception of the response packet and not 625 μs after the received packet as is usual in the piconet physical channel RX/TX timing.

After the Master has sent its FHS packet 416, the Master may wait for a second Slave page response message 418 in step 4 acknowledging the reception of the Master FHS packet 416. This response is the Slaves device access code. If no response is received the Master will retransmit the Master FHS packet with an updated clock and still using the Slave's parameters. Another transmission of the FHS packet may be repeated with the clock updated each time until a second Slave page response message is received, or the time period of page-response time-out is exceeded. During the retransmissions of the FHS packet, the Master may use the page hopping sequence.

If the Slave's response is received, the Master changes to using the Master parameters like the channel access code and the Master clock. Finally, the Master enters the Connection state in step 5, The Master BLUETOOTH device address is used to change to a new hopping sequence, called the basic channel hopping sequence. The basic channel hopping sequence uses all 79 hop channels in a pseudorandom fashion. The Master now sends its first traffic packet in a hop determined with the new (Master) parameters.

This first packet is a POLL packet 420. This packet is sent within a predetermined number of time slots after reception of the FHS packet acknowledgement 418. The Stave may respond with any type of packet. If the POLL packet 420 is not received by the Slave or the POLL packet response 422 is not received by the Master within the predetermined number of time slots the Master and the Slave return to page and page scan substates, respectively.

After the POLL packet 420 is successfully received by the Slave, the pairing setup proceeds to key exchange and authentication 424. Establishment of link keys creates the bonding referred to above and occurs prior to authentication.

Link keys are generated and distributed among the devices in order to be used in the authentication procedure. Since the link keys are secret, they are not obtainable through an inquiry routine in the same way as the BLUETOOTH device addresses. The exchange of the keys takes place during an initialization phase which is carried out separately for each two devices that are using authentication and encryption. The initialization procedures consist of the following five parts: 1) generation of an initialization link key; 2) generation of link key; 3) link key exchange; 4) authentication, and 5) generation of encryption key in each device (optional).

After the initialization procedure, the devices can proceed to communicate, or the link can be disconnected, if encryption is implemented, an algorithm may be used with the proper encryption key derived from the current link key. For any new connection established between two devices, the devices use the common link key for authentication, instead of once more deriving an initialization key from the PIN. A new encryption key derived from that particular link key may be created the next time encryption is activated.

A first link key, the initialization link key, is used temporarily during initialization to facilitate generation of the link key. This key can be derived from any combination of some or all of a BLUETOOTH device address, a PIN code, the length of the PiN (in octets), and a random number. The output from this combination may then be used for key exchange during the generation of a link key. When the devices have performed the link key exchange, the initialization key may be discarded. When the initialization key is generated, the PIN is augmented with the BLUETOOTH device address. If one device has a fixed PIN, the BLUETOOTH device address of the other device may be used. If both devices have a variable PIN, the BLUETOOTH device address of the device that received the random number may be used. Since the maximum length of the PIN used in the algorithm cannot exceed 16 octets, it is possible that not all octets of BLUETOOTH device address will be used. This procedure ensures that the initial key depends on the identity of the device with a variable PIN.

Once created, the unit key may be stored in any available memory, for example in non-volatile memory. If after initialization the unit key is changed, any previously initialized devices will possess a wrong link key. At initialization, the application must determine which of the two parties will provide the unit key as the link key. Typically; this will be the device with restricted memory capabilities, since this device only has to remember its own unit key. The unit key may be transferred to the other party and then stored as the link key for that particular party and associated with its BLUETOOTH address.

After the initial link key is determined, authentication may proceed. The authentication procedure is based on a challenge-response scheme. The verifier sends a message that contains a random number (the challenge) to the claimant. The claimant calculates a response, which may be a function of this challenge, and the claimant's BLUETOOTH device address and/or a shared secret key. The response is sent from the claimant back to the verifier. The verifier checks if the response was correct or not. A successful calculation of the authentication response requires that two devices share knowledge of a secret key. Both the Master and the Slave can be verifiers. If the claimant has a link key associated with the verifier, it calculates the response and sends it to the verifier with a signed response. The verifier checks the response. If the response is not correct, the verifier can end the connection. After replying with a signed response, the claimant may become a verifier and may initiate its own authentication.

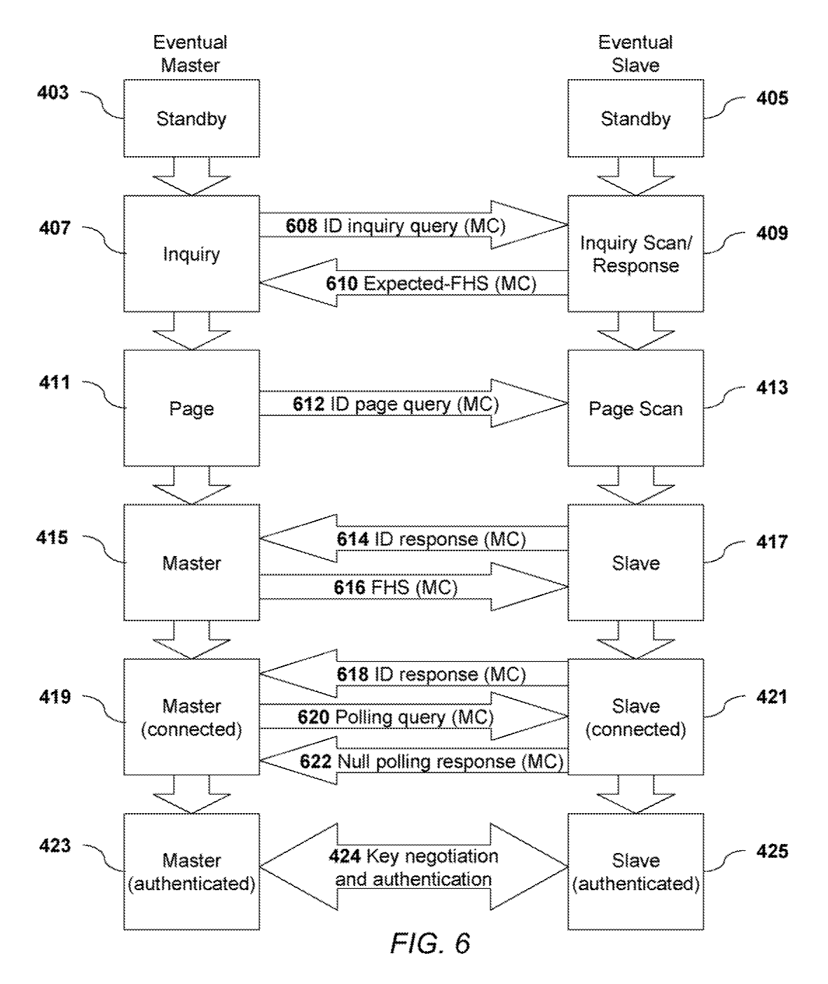

FIG. 6 illustrates locations in the inquiry, paging and pairing/bonding communications in FIG. 4 that Malicious Code may be submitted within a transmission to an unprotected BLUETOOTH device. Malicious Code (MC) includes all and any programs (including macros and scripts) which cause an unexpected or unwanted event on a target device. Open acceptance of transmissions from an unknown or not trusted source could provide a potential security vulnerability that could be exploited by a malicious user to send actual data (including destructive executable programs).

Transmissions containing MC may be sent from either a potential Master device or a potential Slave device. As a non-limiting example, in the inquiry phase of device communications, a device in the position of a potential Master device may send an ID inquiry packet 608 that may contain MC. Alternatively, a device in the position of a potential Slave may respond to a valid ID inquiry (e.g., 408) with a packet that would be expected to be an FHS packet but may contain MC 610.

It should be understood that MC packets may come from any transmission. For example, any of the normal paging communication sequence may contain MC packets on either the potential Master or potential Slave transmission. An initial ID Page query may contain MC 612. The response 614 and expected-FHS packet 616 could also contain MC. Likewise the subsequent expected prior responses leading to establishing a trusted device connection may contain MC (618, 620 and 622).

The number of communications that occur prior to the devices establishing a trusted relation may be made fewer in number than is illustrated in FIG. 4 and FIG. 6, thereby allowing fewer chances for the insertion of MC prior to device authentication. For example, during the link controller connection process the key exchange may be moved to an earlier stage than illustrated in FIG. 4, and may occur within or in connection with the inquiry scan substate.

The communication packets that are received by a device before authentication may be filtered such that the chance of a transmission containing MC affecting a device prior to authentication is minimized. Therefore, before potentially exploitable packet transmissions, or portions of packet transmissions, such as identification, frequency hopping, polling, and null packets can be exchanged with a malicious 3rd party device, BLUETOOTH devices will already have been authenticated with each other as known intended devices. Filters for transmitted packets may be designed to allow only sufficient information to pass that leads directly to key negotiation and authentication. Any data or data fields not directly contributing to establishing a trusted communication link may be blocked. Restricting data this way significantly decreases the possibility MC may affect an exposed device.

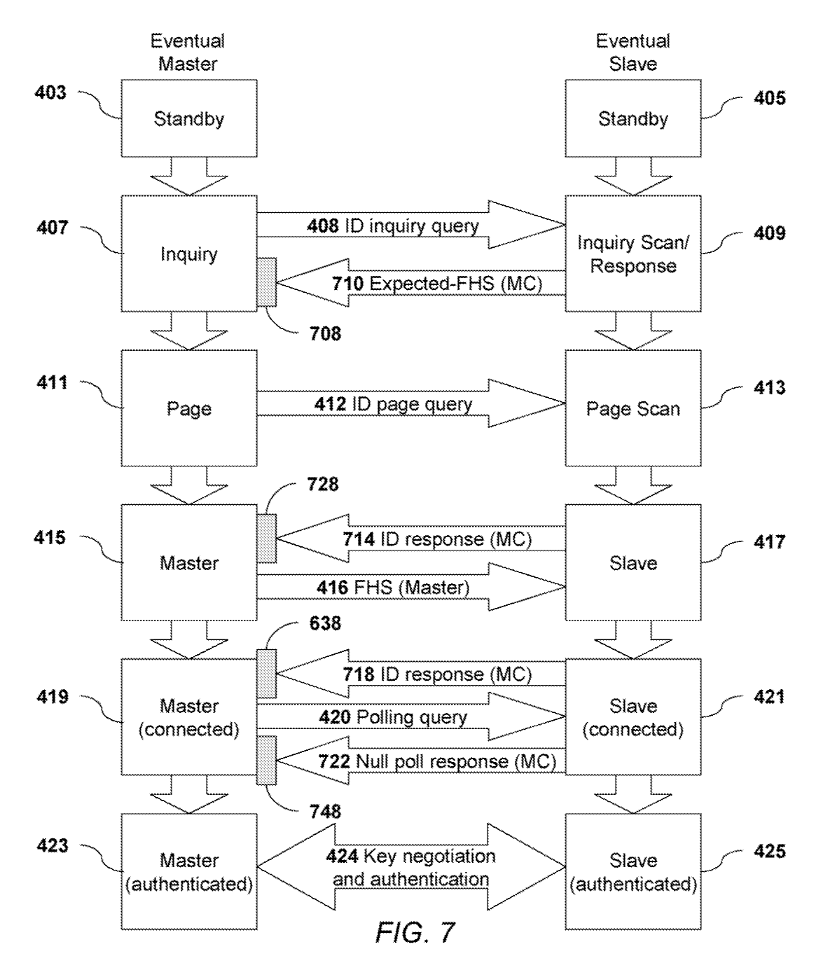

FIG. 7 illustrates an embodiment wherein transmissions from a Stave device to a Master device are filtered to remove data not required for proceeding to authentication. White FIG. 7 illustrates a Master device filtering transmissions received from an authenticated Stave device, the Slave device may also filter transmissions from Master devices or other devices that have not yet been authenticated. Filtering in either direction may be accomplished by selectively blocking data or data fields that do not directly lead to establishing a trusted communication link, for example by contributing to determining an initial link key.

The data may be removed whether MC is present or absent. FIG. 7 illustrates a sequence of communications for a Master device connecting with a Slave device. The BLUETOOTH Master controller may leave the Standby mode 403 to transmit an Inquiry 407 such as an ID query 408. The eventual Slave, from an Inquiry Scan 409 state, transmits a Frequency Hopping Synchronization (FHS) packet 710. This FHS packet 710 received by the Master device is filtered by filter 708 associated with the Master device.

The filter 708, which may be implemented as selective data field blocking, prioritizes data and optionally minimizes, removes, quarantines or masks all data from FHS packet 710 except for specific data, such as information related to establishing an initial link key so that authentication for establishing a trusted communication link may be initiated between Master and Slave. For example, in one embodiment only the data associated with establishing the BLUETOOTH device address of the Slave may be read from packet 710 (or 410) by the Master device. In another embodiment, the Slave BLUETOOTH device address data fields along are extracted by or through the filter along with any parity bits data while all other data or substantially all other data are suppressed, discarded, quarantined, ignored, masked or otherwise filtered. The Slave BLUETOOTH device address is extracted from filtered packet 710 so that the Master may determine a suite of transmission frequencies or frequency hopping sequences to use as it transmits a train of identical page scan messages (e.g., 412) at different hop frequencies and listens in between the transmit intervals until the Master receives a response (e.g., 714) from the Slave

After determining transmission frequencies, transmitting on these frequencies and receiving an appropriate transmission packet response from the Slave, the Master sends an ID page query packet 412 to prompt a pagescan condition 413 within the Slave device and so prompting an ID response packet 714 from the Slave 417. At this point the ID response packet 714 is filtered by the Master 415 to allow enough information to be extracted through filter 728 to allow the Master to determine an ID response has been made. The Master may then transmit an acknowledgement back to the Slave and/or an FHS packet 416 to allow the Slave to determine communication parameters from the Master based on the packet.

Upon receiving FHS packet 416 from the Master 415 the Slave enters a connected state 421. The Slave transmits an ID response packet 718 allowing the Master 119 to assume a connected state, still filtering 738 to only allow a minimum of data from any received data packets from unauthenticated devices even though the Slave is in a connected state 421. As with the embodiment illustrated in FIG. 4, a Polling query 420 may be transmitted to the Slave, which will respond with a verification Null Polling response 722.

After the Master receives this last Null Polling response 722 (that is still filtered 748), the Master and Slave have sufficient information to initiate the initial key link sequence (key negotiation) that leads to authentication 424, and the Master has been protected from MC that may be present in received transmissions, whether from the eventual Slave or other unauthenticated devices.

Key negotiation and authentication 424, whether transmissions have been filtered or not, begins by determining a common initial link key, or initialization key (Kᵢₙᵢₜ) created between the Master and Slave. The Kᵢₙᵢₜ may be based on any number of inputs. Non-limiting examples include a combination of some or all of a PIN, the length of the PIN, a random number and a BLUETOOTH device address. When both devices have calculated Kᵢₙᵢₜ a link key may be created and then a mutual authentication is performed. An authentication may be performed immediately upon determining Kᵢₙᵢₜ or upon calculation of a link key determined subsequent to Kᵢₙᵢₜ.

Kᵢₙᵢₜ may be generated by any suitable method. As a non-limiting example, the BLUETOOTH PIN is used to authenticate two BLUETOOTH devices (that have not previously exchanged link keys) to each other and create a trusted relationship between them. The PIN is used in the pairing procedure to generate the initial link key (or Kᵢₙᵢₜ) that is used for further authentication. The PIN may be entered on a User Interface (UI) level associated with the device but may also be stored in the device; e.g. in the case of a device without sufficient Man-Machine Interface (MMI) for entering and displaying digits. In some cases, a PIN may be assumed (e.g., a default value of zero with a length of one byte, and may be provided by the host) so that a Kᵢₙᵢₜ may be created. The PIN may be a fixed number provided with the device (for example when there is no user interface). Alternatively, the PIN can be selected by the user, and then entered in both devices that are to be matched or paired. The latter procedure may be used when both devices have a user interface, for example with a phone and a laptop. Entering a PIN in both devices is more secure than using a fixed PIN in one of the devices.

All sequences including the mutual authentication after the initial link key has been created form a single transaction. The transaction ID (placed in packet headers) may be used for all subsequent sequences for the single transaction.

As another non-limiting example, when the initiating device sends an initial random number, the responder replies with an acceptance message. Both devices then calculate Kᵢₙᵢₜ based on the BLUETOOTH device address of the responder and then the procedure continues with creation of the link key.

The link key created in the pairing procedure may either be a combination key or one of the device's unit keys. Any suitable rules may be applied to selecting a link key. A non-limiting set of rules that may be applied to the selection of the link key include: 1) if one device sends a unit key and the other device sends a combination key, the unit key will be the link key; 2) if both devices send a unit key, the Master's unit key will be the link key; 3) if both devices send a combination key, the link key may be calculated as the combination of two numbers generated in each device.

A combination key may be generated during the key initialization procedure. The combination key is the combination of two numbers generated in Device A and Device B, respectively. First, each device may generate a random number, e.g., RAND-A for Device A and RAND-B for Device B. Utilizing a chosen algorithm with the random number and their own BLUETOOTH device address, the two random numbers are then combined to create device specific random numbers in Device A and Device B, respectively. These device specific random numbers constitute the devices' contribution to the combination key that is to be created. Then, the two random numbers are exchanged securely by XQRing with the current link key. Thus, device A may send RAND-A XORed with the current link key to device B, while device B may send RAND-B XORed with the current link key to device A. If this is done during the initialization phase the link key is Kᵢₙᵢₜ.

When the random numbers and have been mutually exchanged each device recalculates the other device's contribution to the combination key. This is possible since each device knows the BLUETOOTH device address of the other device. After this, both devices may combine the two numbers to generate the link key. The combining operation may be a simple bitwise modulo-2 addition (i.e. XOR). The result may be stored in Device A as the link key for Device A and in Device B as the link key for Device B. When both devices have derived the new combination key, a mutual authentication procedure may be initiated to confirm the success of the transaction. The old link key (e.g., the original Kᵢₙᵢₜ) may be discarded after a successful exchange of a new combination key.

When the link key, combination or unit key, has been created mutual authentication may be performed to confirm that the same link key has been created in both devices. The first authentication in the mutual authentication is performed with the initiator as the verifier. Next, an authentication in the reverse direction is performed.

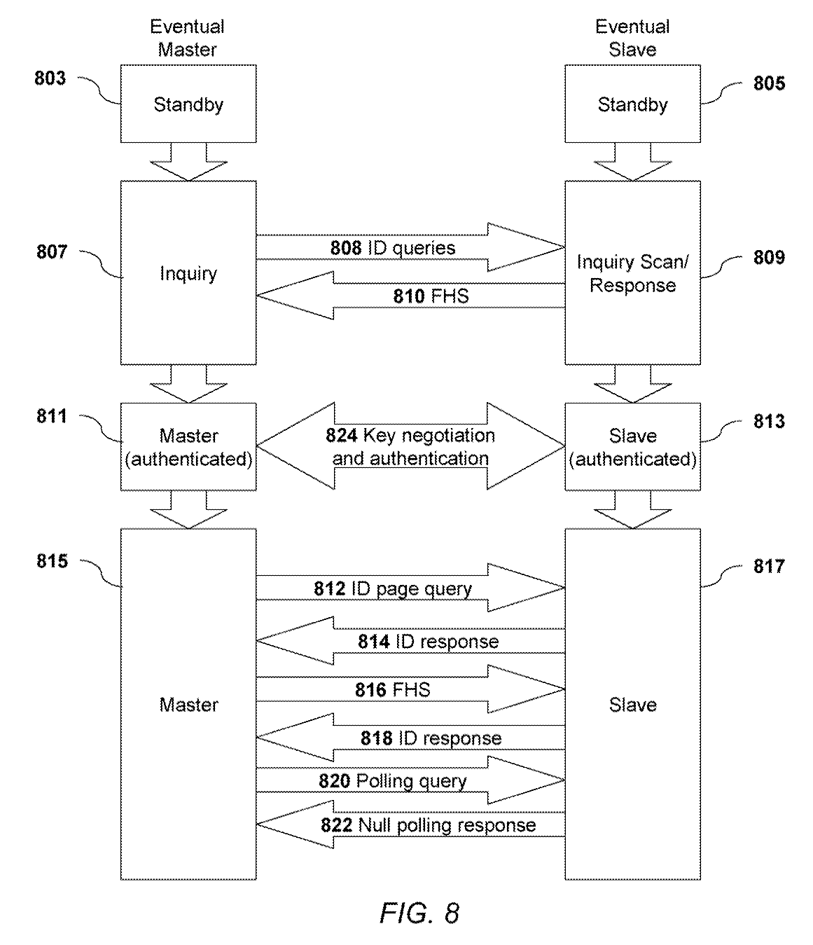

FIG. 8 illustrates an embodiment with the key negotiation and authentication taking place subsequent to device discovery. A Master transmits an ID inquiry packet 808 which prompts an FHS packet response 810. The BLUETOOTH device address of the Slave is read by the Master from the FHS packet 810. Either packet may be filtered by the receiving device.

The Slave BLUETOOTH device address is extracted from packet 810. The Master may determine a suite of transmission frequencies to transmit a train of messages at different hop frequencies to establish an initial link key (Kᵢₙᵢₜ) and listen in between the transmit intervals until the Master receives a response from the Slave indicating key negotiation for Kᵢₙᵢₜ is underway.

This initialization link key, Kᵢₙᵢₜ, is used temporarily during initialization to facilitate generation of the link key. This initial key may be derived from a combination of some or all of a BLUETOOTH device address, a PIN code, the length of the PIN (in octets), and a random number. The output from this combination may then be used for authentication or for key exchange during the generation of a link key. When the devices have performed the link key exchange, the initialization key may be discarded. When the initialization key is generated, the PIN is augmented with the BLUETOOTH device address. If one device has a fixed PIN the BLUETOOTH device address of the other device may be used. If both devices have a variable PIN, the BLUETOOTH device address of the device that received the random number may be used. Since the maximum length of the PIN used in the current algorithm does not exceed 16 octets, it is possible that not all octets of BLUETOOTH device address will be used with the current algorithm. This procedure ensures that the initial key depends on the identity of the device with a variable PIN.

Each device transmits a PIN and/or a random number as appropriate The Kᵢₙᵢₜ may be based on one or more of a PIN, a random number and a device BLUETOOTH address. When both devices have calculated Kᵢₙᵢₜ the link key may be created and then a mutual authentication is performed. An authentication may be performed immediately upon determining Kᵢₙᵢₜ or upon calculation of a link key determined subsequent to Kᵢₙᵢₜ.

After Kᵢₙᵢₜ has been established, an initial authentication may be conducted or the communication parameters may be optimized if necessary. For example in one embodiment, upon receipt by the Master of an FHS packet, a sequence leading to determining Kᵢₙᵢₜ is undertaken, authentication takes place, and then the devices continue through sequences that include establishing a suite of hopping frequencies to remain on during subsequent communications. Whether the data packets 812 through 822 inclusive are exchanged will depend on whether the key negotiation/authentication sequences led to the establishment of frequency hopping sequences for device communications.

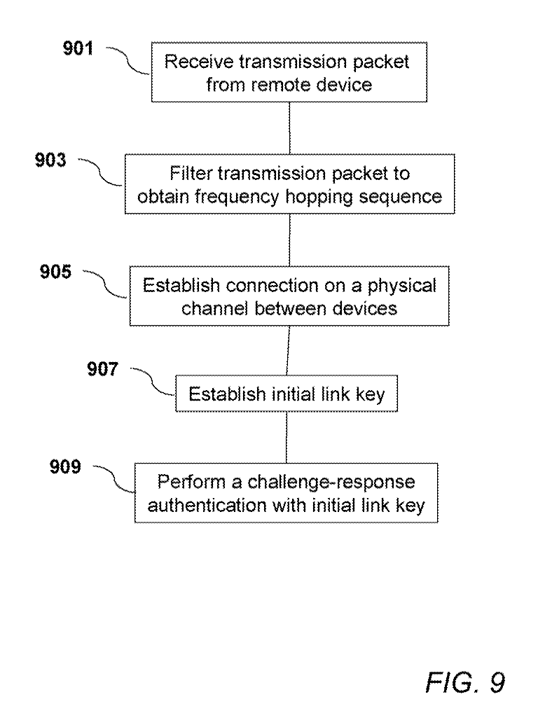

FIG. 9 illustrates an embodiment wherein a portion of a data packet transmission received 901 from a remote device is blocked, for example a transmission from a remote or potential Slave device. The received transmission may be a response to a query by a potential Master device (e.g., 408 in FIG. 4 or FIG. 7). Information is extracted to determine a frequency hopping sequence so that the Master may target hopping frequencies to establish a connection over a physical channel 905. An initial link key between the devices is then established 907. The initial link key may be based on a combination of some or all of a BLUETOOTH device address, a PIN code, the length of the PIN (in octets), and a random number. A challenge response authentication 909 may be undertaken between the Master and Slave device with the initial link key. The Master or Slave may initiate the authentication. Alternatively, a link key subsequent to the initial link key may be determined prior to authentication.

The filtering performed on the received transmissions may take the form of quarantining the entire packet and extracting selected data, for example the BLUETOOTH device access code and/or parity bits. Quarantined data fields may be retrieved after device authentication is completed. Alternatively the transmission packet may be filtered by the receiving device such that all data fields except a selected field is ‘masked’ or selectively blocked in a manner that only the desired data or data fields are acquired. In another embodiment filtering includes blocking or discarding all data fields without reading the data as the transmission is received except for one or more selected fields.

In one embodiment a method for establishing a trusted communication link between a first device and a second device includes blocking, at the first device, at least a portion of data in a data packet transmitted from the second device, to obtain unblocked data. A frequency hopping sequence is determined using at least a portion of the unblocked data. A connection on a physical channel is established between the first device and the second device with the frequency hopping sequence and an initial link key is established using at least a portion of the unblocked data.

In another embodiment a challenge-response authentication process is performed between the first device and second device with the initial link key. In another embodiment the initial link key is based on at least one of: a Personal Identification Number, a BLUETOOTH device address, a random number and a length of the Personal Identification Number. Another embodiment includes blocking data includes extracting only a BLUETOOTH device address from the data packet. In another embodiment blocking the data includes quarantining at least a portion of the received data packet and extracting a BLUETOOTH device address. In another embodiment at least a portion of the unblocked data is used to determine one of: a BLUETOOTH device address, a channel access code, a device access code, a clock parameter, a device class, a page scan mode, a BLUETOOTH device name, a lower address part, an upper address part, and a non-significant address part. In another embodiment the transmission is received in response to one of: a General Inquiry Access Code (GIAC) and a Dedicated Inquiry Access Code (DIAC).

In another embodiment, a set of application program interfaces embodied on a computer readable medium for execution by a processor included in a first device for establishing a trusted communication link with a second device includes a first interface that receives data from a first portion of a wireless data packet transmitted from the second device to obtain at least a portion of an unblocked packet data, wherein a second portion of the data in the wireless data packet is blocked packet data, a second interface that receives data extracted from at least a portion of the unblocked packet data to determine a frequency hopping sequence for establishing a communication link with the second device, a third interface that receives data from a connection on a physical channel associated with the communication link and a fourth interface that receives an initial link key for establishing the communication link as a trusted communication link between the first device and the second device, wherein the initial link key is associated with at least a portion of the unblocked packet data.

Another embodiment includes an interface to receive data from a challenge-response authentication interaction between the first device and second device the challenge-response authentication using the initial link key. In another embodiment an interface receives quarantined data from at least a portion of the blocked packet data. In another embodiment the set of application interface programs receives data associated with a BLUETOOTH device address extracted from at least a portion of the unblocked packet data, in another embodiment the initial link key is associated with at least one of: a Personal Identification Number, a BLUETOOTH device address, a random number and a length of the Personal Identification Number.

In another embodiment an information handling system (IHS) includes a transceiver configured to receive a wireless transmission communication data packet, a physical channel for communication of the data packet and a processor configured to process instructions to block at least a portion of data in the wireless communication packet wherein unblocked data is used to determine a frequency hopping sequence and an initial link key for trusted communications.

In another embodiment the initial link key is based on one of i) a BLUETOOTH device address, ii) a PIN code iii) a length of a PIN and iv) a random number. In another embodiment at least a portion of the unblocked data are associated with a BLUETOOTH device address. In another embodiment the frequency hopping sequence is determined using a BLUETOOTH device address In another embodiment at least a portion of the unblocked data are associated with: i) a PIN code ii) a random number and iii) parity bits. In another embodiment at least a portion of the blocked data not associated with determining the hopping sequence is quarantined. In another embodiment at least a portion of the unblocked data enables determination of one of a channel access code, a device access code, a clock parameter, a device class, a page scan mode, and a BLUETOOTH device name. In another embodiment the initial link key is used in a challenge-response authentication process. In another embodiment blocking at least a portion of the data includes one of: suppressing, discarding, quarantining, and masking the data.

In another embodiment a method for establishing an initial link key between a first BLUETOOTH device and a second BLUETOOTH device includes blocking, at the first BLUETOOTH device, at least a portion of data in a data packet transmitted from the second BLUETOOTH device, to obtained unblocked data and determining a frequency hopping sequence using at least a portion of the unblocked data.

Another embodiment includes establishing a connection on a physical channel between the first BLUETOOTH device and the second BLUETOOTH device using the frequency hopping sequence. Another embodiment includes establishing an initial link key using at least a portion of the unblocked data. Another embodiment includes performing a challenge-response authentication process between the first device and second device with the initial link key. In another embodiment the initial link key is based on at least one of: a Personal Identification Number, a BLUETOOTH device address, a random number and a length of the Personal Identification Number. In another embodiment blocking data includes extracting only a BLUETOOTH device address from the data packet. Another embodiment blocking data includes quarantining at least a portion of the received data packet and extracting a BLUETOOTH device address. In another embodiment at least a portion of the unblocked data is used to determine one of: a BLUETOOTH device address, a channel access code, a device access code, a clock parameter, a device class, a page scan mode, a BLUETOOTH device name, a lower address part, an upper address part and a non-significant address part.

While various embodiments have been shown and described, various modifications and substitutions may be made thereto without departing from the spirit and scope of the invention. Accordingly, it is to be understood that the present invention has been described by way of illustrations and not limitation.

1) A method for establishing an initial link key between a first device and a second device comprising:
blocking, at the first device, at least a portion of data in a data packet transmitted from the second device, to obtain unblocked data;
determining a frequency hopping sequence using at least a portion of the unblocked data;
establishing a connection on a physical channel between the first device and the second device with the frequency hopping sequence; and
establishing an initial link key using at least a portion of the unblocked data.

2) The method of claim 1 further comprising:
performing a challenge-response authentication process between the first device and second device with the initial link key.

3) The method of claim 1 wherein the initial link key is based on at least one of: a Personal Identification Number, a BLUETOOTH device address, a random number and a length of the Personal Identification Number.

4) The method of claim 1 wherein blocking data further comprises extracting only a BLUETOOTH device address from the data packet.

5) The method of claim 1 wherein blocking data further comprises quarantining at least a portion of the received data packet and extracting a BLUETOOTH device address.

6) The method of claim 1 wherein at least a portion of the unblocked data is used to determine one of a BLUETOOTH device address, a channel access code, a device access code, a crock parameter, a device class, a page scan mode, a BLUETOOTH device name, a tower address part, an upper address part, and a non-significant address part.

7) A set of application program interfaces embodied on a computer readable medium for execution by a processor included in a first device for establishing a trusted communication link with a second device comprising:
a first interface that receives data from a first portion of a wireless data packet transmitted from the second device to obtain at least a portion of an unblocked packet data, wherein a second portion of the data in the wireless data packet is blocked packet data;
a second interface that receives data extracted from at least a portion of the unblocked packet data to determine a frequency hopping sequence for establishing a communication link with the second device;
a third interface that receives data from a connection on a physical channel associated with the communication link; and
a fourth interface that receives an initial link key for establishing the communication link as a trusted communication link between the first device and the second device, wherein the initial link key is associated with at least a portion of the unblocked packet data.

8) The set of application interface programs according to claim 7 further comprising a fifth interface to receive data from a challenge-response authentication interaction between the first device and second device, the challenge-response authentication using the initial link key.

9) The set of application interface programs according to claim 7 wherein the second interface receives quarantined data from at least a portion of the blocked packet data.

10) The set of application interface programs according to claim 7 wherein the second interface receives data associated with a BLUETOOTH device address extracted from at least a portion of the unblocked packet data.

11) The set of application interface programs according to claim 7 wherein the initial link key is associated with at least one of: a Personal Identification Number, a BLUETOOTH device address, a random number and a length of the Personal Identification Number.

12) An information handling system (IHS) comprising:
a transceiver configured to receive a wireless transmission communication data packet;
a physical channel for communication of data in the data packet; and
a processor configured to process instructions to block at least a portion of data in the wireless communication packet wherein unblocked data is used to determine a frequency hopping sequence and an initial link key for trusted communications.

13) The system of claim 12 wherein the initial link key is based on one of i) a BLUETOOTH device address, ii) a PIN code, iii) a length of a PIN and iv) a random number.

14) The system of claim 12 wherein at least a portion of the unblocked data are associated with a BLUETOOTH device address.

15) The system of claim 12 wherein the frequency hopping sequence is determined using a BLUETOOTH device address.

16) The system of claim 12 wherein at least a portion of the unblocked data are associated with: i) a PIN code, ii) a random number and iii) parity bits.

17) The system of claim 12 wherein at least a portion of the blocked data not associated with determining a frequency hopping sequence is quarantined.

18) The system of claim 12 wherein at least a portion of the unblocked data enables determination of one of: a channel access code, a device access code, a clock parameter a device class, a page scan mode, and a BLUETOOTH device name.

19) The system of claim 12 wherein the initial link key is used in a challenge-response authentication process.

20) The system of claim 12 wherein blocking at least a portion of the data further comprises one of suppressing, discarding, quarantining, and masking the data.
